(19) United States
(12) Patent Application Publication
(10) Pub. No.: US 2026/0344773 A1
(43) Pub. Date: Nov. 5, 2026

(54) AEROSOL-GENERATING DEVICE COMPRISING A POROUS HEATING ELEMENT

(71) Applicant: Philip Morris Products S.A., Neuchatel (CH)

(72) Inventor: Rui Nuno Rodrigues Alves BATISTA, Morges (CH)

(73) Assignee: Philip Morris Products S.A., Neuchatel (CH)

(21) Appl. No.: 19/485,875

(22) PCT Filed: May 13, 2024
(86) PCT No.: PCT/EP2024/063050

§ 371 Date: Nov. 19, 2025

(30) Foreign Application Priority Data
May 22, 2023 (EP) 23174614.0

(51) Int. Cl. A24F 40/465; A24F 40/20; A24F 40/30; A24F 40/485

(52) U.S. Cl. CPC A24F 40/465; A24F 40/20; A24F 40/30; A24F 40/485

(57) ABSTRACT

An aerosol-generating device is provided, including: a first cavity to receive a first aerosol-forming substrate; a second cavity to receive a second aerosol-forming substrate; and a heating arrangement including a first porous heating element, the first porous heating element being arranged in a first airflow channel between the first cavity and the second cavity, the first porous heating element being further arranged abutting the first cavity and the second cavity, and the first porous heating element being fluidly connected with both of the first cavity and the second cavity.

It is known to provide an aerosol-generating device for generating an inhalable vapor. Such devices may heat aerosol-forming substrate to a temperature at which one or more components of the aerosol-forming substrate are volatilised without burning the aerosol-forming substrate. Aerosol-forming substrate may be provided as part of an aerosol-generating article. The aerosol-generating article may have a rod shape for insertion of the aerosol-generating article into a cavity, such as a heating chamber, of the aerosol-generating device. A heating element may be arranged in or around the heating chamber for heating the aerosol-forming substrate once the aerosol-generating article is inserted into the heating chamber of the aerosol-generating device.

It would be desirable to provide an aerosol-generating system with improved heating efficiency. It would be desirable to provide an aerosol-generating system with improved temperature control. It would be desirable to provide an aerosol-generating system with improved aerosol generation. It would be desirable to provide an aerosol-generating system having an improved airflow through the system. It would be desirable to provide an aerosol-generating system with an improved aerosol delivery. It would be desirable to provide an aerosol-generating system which can be manufactured with enhanced flexibility. It would be desirable to provide an aerosol-generating device for use with multiple aerosol-forming substrates.

According to a first aspect of the invention there is provided an aerosol-generating device. The device comprises a first cavity configured for receiving a first aerosol-forming substrate. The device comprises a second cavity configured for receiving a second aerosol-forming substrate. The device comprises a heating arrangement comprising a first porous heating element. The first porous heating element is arranged in a first airflow channel between the first cavity and the second cavity. The first porous heating element is arranged abutting the first cavity and the second cavity. The first porous heating element is fluidly connected with one or both of the first cavity and the second cavity.

According to an embodiment of the invention there is provided an aerosol-generating device. The device may comprise a first cavity configured for receiving a first aerosol-forming substrate. The device may comprise a second cavity configured for receiving a second aerosol-forming substrate. The device may comprise a heating arrangement comprising a first porous heating element. The first porous heating element may be arranged in a first airflow channel between the first cavity and the second cavity. The first porous heating element may be arranged abutting the first cavity and the second cavity. The first porous heating element may be fluidly connected with one or both of the first cavity and the second cavity.

The first cavity may be configured for receiving a first aerosol-generating article. The first aerosol-generating article may comprise the first aerosol-forming substrate. The second cavity may be configured for receiving a second aerosol-generating article. The second aerosol-generating article may comprise the second aerosol-forming substrate.

The first heating element may be arranged parallel to the first cavity. The first heating element may be arranged parallel to the second cavity. The first heating element may line at least a portion of the first cavity. The first heating element may line at least a portion of the second cavity. The first heating element may be in contact with the first cavity. The first heating element may be in contact with the second cavity. The first cavity may be arranged radially outward of the first heating element. The second cavity may be arranged radially outward of the first heating element. The first heating element may be in contact with one or both of the first aerosol-forming substrate and the first aerosol-generating article. The first heating element may be in contact with one or both of the second aerosol-forming substrate and the second aerosol-generating article.

By providing the first heating element in contact with one or both of the first cavity and the second cavity, the transfer of heat from the first heating element to one or both of the first aerosol-forming substrate and the second aerosol-forming substrate may be improved

The first heating element may be configured to heat the first aerosol-forming substrate inserted into the first cavity. The first heating element may be configured to heat the first aerosol-forming substrate of the first aerosol-generating article.

The first heating element may be configured to heat the second aerosol-forming substrate inserted into the second cavity. The first heating element may be configured to heat the second aerosol-forming substrate of the second aerosol-generating article inserted into the second cavity.

The first heating element may be configured to be in fluidly connected with the first cavity. The first heating element may be configured to be fluidly connected with the second cavity.

The first cavity may be cuboid-shaped. The first cavity may have a rectangular cross-section. The first cavity may be planar. The first cavity may be flat. The first cavity may be configured to closely match the shape of the first aerosol-forming substrate. The first cavity may be configured to closely match the shape of the first aerosol-generating article. The first cavity may be configured to slidably receive the first aerosol-forming substrate. The first cavity may be configured to slidably receive the first aerosol-generating article.

The second cavity may be cuboid-shaped. The second cavity may have a rectangular cross-section. The second cavity may be planar. The second cavity may be flat. The second cavity may be configured to closely match the shape of the second aerosol-forming substrate. The second cavity may be configured to closely match the shape of the second aerosol-generating article. The second cavity may be configured to slidably receive the second aerosol-forming substrate. The second cavity may be configured to slidably receive the second aerosol-generating article.

The shape of the first cavity and the shape of the second cavity may be the same. Alternatively, the shape of the first cavity and the shape of the second cavity may be different.

The first heating element may be cuboid-shaped. The first heating element may have a rectangular cross-section. The first heating element may be planar. The first heating element may be flat.

The first airflow channel may be configured for receiving the first heating element. The first heating element may be arranged in the first airflow channel. The first airflow channel may be cuboid-shaped. The first airflow channel may have a rectangular cross-section. The first airflow channel may be planar. The first airflow channel may be flat. The first airflow channel may be configured to closely match the shape of the first heating element.

The device may comprise a porous second heating element. The second heating element may be cuboid-shaped. The second heating element may have a rectangular cross-section. The second heating element may be planar. The second heating element may be flat.

One or both of the second heating element may be made from a ferromagnetic alloy. One or both of the second heating element may be made from a stainless steel alloy.

The device may comprise a second airflow channel. The second airflow channel may be configured for receiving the second heating element. The second heating element may be arranged in the second airflow channel. The second airflow channel may be cuboid-shaped. The second airflow channel may have a rectangular cross-section. The second airflow channel may be planar. The second airflow channel may be flat. The second airflow channel may be configured to closely match the shape of the second heating element.

The first cavity may comprise an open end. The first cavity open end may be arranged at a downstream end of the first cavity. The second cavity may comprise an open end. The second cavity open end may be arranged at a downstream end of the second cavity. The first airflow channel may comprise an open end. The first airflow channel open end may be arranged at a downstream end of the first airflow channel. The second airflow channel may comprise an open end. The second airflow channel open end may be arranged at a downstream end of the second airflow channel.

The first aerosol-forming substrate may be inserted into the first cavity via the first cavity open end. The first aerosol-generating article may be inserted into the first cavity via the first cavity open end. The second aerosol-forming substrate may be inserted into the second cavity via the second cavity open end. The second aerosol-generating article may be inserted into the second cavity via the second cavity open end.

The aerosol-generating system may provide improved heating efficiency. The aerosol-generating system may provide improved temperature control. The aerosol-generating system may provide improved aerosol generation. The aerosol-generating system may provide an improved airflow through the system. The aerosol-generating system may provide an improved aerosol delivery. The aerosol-generating system may be manufactured with enhanced flexibility. The aerosol-generating device may be used with multiple aerosol-forming substrates. The aerosol-generating device may provide improved resistance to draw (RTD). The aerosol-generating device may provide improved aerosol generation. The aerosol-generating device may provide an improved user experience. The aerosol-generating device may provide improved mixing of external air and volatized aerosol-forming substrate. The aerosol-generating device may provide an aerosol of improved homogeneity. The aerosol-generating device may provide improved control of the temperature profile across in inserted substrate article.

The characteristics of the porous heating element may be easily and effectively be tuned. The airflow characteristic of the porous heating element may be tuned by adjusting the porosity of the heating element. The heating profile delivered by the porous heating element may be tuned. The porous heating element may provide reduced risk of damaging a an article or substrate during insertion into the device. The heating characteristics of the porous heating element may be tuned by adjusting one or both of the porosity and the material of the heating element of one or more different portions of the heating element.

The first porous heating element may have a sponge-like structure or a foam-like structure.

The porous structure may provide an airflow path through the first porous heating element. The upstream end of the first porous heating element may be fluidly connected to the downstream end of the first porous heating element via the porous structure. The first airflow channel inlet may be fluidly connected to the open end of the first airflow channel by the first porous heating element.

The second porous heating element may have a sponge-like structure or a foam-like structure.

The porous structure may provide an airflow path through the second porous heating element. The upstream end of the second porous heating element may be fluidly connected to the downstream end of the second porous heating element via the porous structure. The second airflow channel inlet may be fluidly connected to the open end of the second airflow channel by the second porous heating element.

The porosity range of the heating element may be between 35% and 75%, preferably of between 40% and 65%, and most preferably of between 45% to 55%.

The porosity may be the ratio of the volume of material (Vₚ) in the porous heating element and the total volume of the porous heating element (Vₜ).

The first porous heating element may be planar.

The first porous heating element may comprise a first portion and a second portion. The second porous heating element may comprise a first portion and a second portion.

The first portion of the first porous heating element may comprise a first porosity. The second portion of the first porous heating element comprises a second porosity. The first portion of the second porous heating element may comprise a first porosity. The second portion of the second porous heating element comprises a second porosity.

The first porosity may be the ratio of the volume of material (Vₚ₁) in the first portion of the heating element and the total volume (Vₜ₁) of the first portion of the heating element. The second porosity may be the ratio of the volume of material (Vₚ₂) in the second portion of the heating element and the total volume (Vₜ₂) of the second portion of the heating element.

The porosity range of one or both of the first porosity and the second porosity may be between 35% and 75%, preferably of between 40%and 65%, and most preferably of between 45% to 55%.

The first portion of the first porous heating element is may be made from a first material. The second portion of the first porous heating element may be made from a second material. The first portion of the second porous heating element is may be made from a first material. The second portion of the second porous heating element may be made from a second material.

The first material may be different from the second material. The first material may have a first electromagnetic response to an alternating magnetic field. The second material may have a second electromagnetic response to an alternating magnetic field. The first electromagnetic response may be different to the second electromagnetic response.

The heating profile provided by the first portion of the heating element may be different to heating profile provided by the second portion of the heating element.

The first portion of the first porous heating element may be configured abutting the second portion of the first porous heating element. The first portion of the second porous heating element may be configured abutting the second portion of the second porous heating element.

The first portion of the first porous heating element may be in contact with the second portion of the porous heating material.

The second portion of the first porous heating element may be arranged proximal to the first portion of the first porous heating element. The second portion of the second porous heating element may be arranged proximal to the second portion of the first porous heating element.

Provision of a porous heating element having the second portion arranged proximal to a second portion may enable the provision of different heating profiles to different portions of the aerosol-forming substrates. The second portion may heat the proximal portions of one or both of the first aerosol-forming substrate and the second aerosol-forming substrate. The first portion may heat the distal portions of one or both of the first aerosol-forming substrate and the second aerosol-forming substrate. The different heating profiles may result from one or both of (i) different power supplies to the first induction coil and the second induction coil and (ii) different configurations, such as porosity and material, of the first portion and second portion.

The first portion of the first porous heating element and the second portion of the first porous heating element may be arranged abutting the first cavity and the second cavity.

The first portion of the first porous heating element may be in contact with one or both of a first portion of the first cavity and a first portion of the second cavity. The second portion of the first porous heating element may be in contact with one or both of a second portion of the first cavity and a second portion of the second cavity. The second portion of the first cavity may be arranged proximal to the first portion of the first cavity. The second portion of the second cavity may be arranged proximal to the first portion of the second cavity.

The first portion of the first porous heating element may be configured to heat one or both of the first portion of the first cavity and the first portion of the second cavity. The second portion of the first porous heating element may be configured to heat one or both of the second portion of first cavity and the second portion of the second cavity.

The first portion of the first porous heating element may be configured to heat one or both of at least a first portion of a first aerosol-forming substrate inserted into the first cavity and a first portion of a second aerosol-forming substrate inserted into the second cavity. The second portion of the first porous heating element may be configured to heat one or both of a second portion of the first aerosol-forming substrate inserted into the first cavity and a second portion of the second aerosol-forming substrate inserted into the second cavity.

The first portion of the first porous heating element may be configured to heat one or both of at least a first portion of a first generating article inserted into the first cavity and a first portion of a second generating article inserted into the second cavity. The second portion of the first porous heating element may be configured to heat one or both of a second portion of the first generating article inserted into the first cavity and a second portion of the second generating article inserted into the second cavity.

The first portion of the first porous heating element and the second portion of the first porous heating element may be arranged parallel to each other. The first portion of the second porous heating element and the second portion of the second porous heating element may be arranged parallel to each other.

Provision of a porous heating element having the first portion arranged parallel to the second portion may enable the provision of different heating profiles to the first aerosol-forming substrate and the second aerosol-forming substrate. The first portion may be heated by the first induction coil. The second portion may be heated by the second induction coil. The first portion of the heating element may heat the first aerosol-forming substrate. The second portion of the heating element may heat the second aerosol-forming substrate. The different heating profiles may result from one or both of (i) different power supplies to the first induction coil and second induction and (ii) different configurations, such as porosity and material, of the first portion and second portion.

The first portion of the porous heating element and the second portion of the porous heating element may form a stack.

The first portion of the first porous heating element may be arranged abutting the first cavity. The second portion of the first porous heating element may be arranged abutting the second cavity.

The first portion of the first porous heating element may be in contact with the first cavity. The second portion of the first porous heating element may be in contact with the second cavity. The first portion of the first porous heating element may be configured to heat the first cavity. The second portion of the first porous heating element may be configured to heat the second cavity. The first portion of the first porous heating element may be configured to heat the first aerosol-forming substrate inserted into the first cavity. The second portion of the first porous heating element may be configured to heat the second aerosol-forming substrate inserted into the second cavity. The first portion of the first porous heating element may be configured to heat the first aerosol-generating article inserted into the first cavity. The second portion of the first porous heating element may be configured to heat the second aerosol-generating article inserted into the second cavity.

The first porous heating element may comprise a first surface configured to abut the first cavity. The first surface of the first heating element may be configured to be in contact with one or both of the inserted first substrate and the inserted first article. The first porous heating element may comprise a second surface configured to abut the second cavity. The second surface of the first heating element may be configured to be in contact with one or both of the inserted second substrate and the inserted second article. One or both of the first surface and the second surface may be configured to be smooth.

The first surface of the first porous heating element may be configured as the heating surface. The second surface of the first porous heating element may be configured as a heating surface.

The first surface of the first porous heating element may be configured to heat at least a portion of the first aerosol-forming substrate inserted into the first cavity. The second surface of the first porous heating element may be configured to heat at least a portion of the second aerosol forming substrate inserted into the second cavity. The first portion of the first porous heating element may be configured to heat at least a portion of the first aerosol-generating article inserted into the first cavity. The second portion of the first porous heating element may be configured to heat at least a portion of the second aerosol-generating article inserted into the second cavity.

The porosity of the first surface may be different to the porosity of the second surface. The heating profile provided by the first surface may be different to heating profile provided by the second surface. The first surface may be made from a different material than the second surface. The first surface may have a different electromagnetic response to an alternating magnetic field than the second surface.

The first portion of the first heating element may comprise a first surface. The first surface of the first portion of the first heating element may be configured as a heating surface. The first portion of the first heating element may comprise a second surface. The second surface of the first portion of the first heating element may be configured as a heating surface. The porosity of the first surface of the first portion of the first heating element may be the same as the porosity of the second surface of the first portion of the first heating element. The first surface of the first portion of the first heating element may be made from the same material as the second surface of the first portion of the first heating element. The first surface of the first portion of the first heating element may have the same electromagnetic response to an alternating magnetic field as the second surface of the first portion of the first heating element.

The first surface of the first portion of the first heating element may be in contact with a first portion of the first cavity. The second surface of the first portion of the first heating element may be in contact with first portion of the second cavity. The first surface of the first portion of the first heating element may be configured to heat a first portion of the first aerosol-forming substrate inserted into the first cavity. The second surface of the first portion of the first heating element may be configured to heat a first portion of the second aerosol-forming substrate inserted into the second cavity.

The second portion of the first heating element may comprise a first surface. The first surface of the second portion of the first heating element may be configured as a heating surface. The second portion of the first heating element may comprise a second surface. The second surface of the second portion of the first heating element may be configured as a heating surface. The porosity of the first surface of the second portion of the first heating element may be the same as the porosity of the second surface of the second portion of the first heating element. The first surface of the second portion of the first heating element may be made from the same material as the second surface of the second portion of the first heating element. The first surface of the second portion of the first heating element may have the same electromagnetic response to an alternating magnetic field as the second surface of the second portion of the first heating element.

The first surface of the second portion of the first heating element may be in contact with a second portion of the first cavity. The second surface of the second portion of the first heating element may be in contact with second portion of the second cavity. The first surface of the second portion of the first heating element may be configured to heat a second portion of the first aerosol-forming substrate inserted into the first cavity. The second surface of the second portion of the first heating element may be configured to heat a second portion of the second aerosol-forming substrate inserted into the second cavity.

The first porous heating element may be produced by sintering. The second porous heating element may be produced by sintering.

Production of the heating element using sintering may obtain heating elements of low surface abrasivity. Heating elements with low friction surfaces may be produced using sintering. Heating elements may be flexibly produced in large volumes and at competitive cost using sintering. By producing the heating element using sintering, it is possible to design and produce the heating element with very consistent and tight specifications of porosity and electromagnetic response. The heating element produced using sintering may reduce the risk of damaging the aerosol-forming substrate or aerosol-generating article during insertion into the first or second cavity.

Sintering may be a process which can be used to bind together small particles or granules. Sintering may be a process by which particles or granules may be partially fused together. The particles or granules may be metallic. The particles or granules may be made of ferromagnetic alloy. The particles or granules may be made from stainless steel alloys. The particles or granules may be spherical.

In the sintering process the particle or granule material is submitted to high temperature and pressure. The temperature and pressure may be such that the material's melting point is not reached. The temperature may be lower than 400 °C. The heat and pressure may be applied to compact the material into a compact solid piece.

One or more of a complementary material, having a lower melting point, may be added in powder form, such that this complementary material melts in the process. The one or more complementary material may help rearranging and binding the material.

The porosity of the sintered heating element may have a range of between 20% and 80%. The porosity of the sintered heating element may be defined with very high precision, because the granulometry of the granules or particles used can be narrow and precisely defined. The granulometry may refer to the size distribution of the particles or granules. The porosity of the heating element may depend on the size of the particles or granules from which the heating element is produced. Particles or granules of one or more, different sizes and different materials may be combined in a single heating element using sintering. Heating elements of a large variety of shapes may be produced using sintering

The device may comprise an aerosol outlet. The first porous element may be configured to fluidly connect one or both of the first cavity and the second cavity with the aerosol outlet.

One or both of the first cavity and the second cavity may be planar.

The first porous heating element may be a resistive heating element. The second porous heating element may be a resistive heating element.

The heating arrangement may comprise a first planar induction coil. The first planar induction coil may be configured abutting the first cavity.

The first induction coil may have a rectangular cross-section. The first induction coil may be flat. The first induction coil may be cuboid-shaped.

The first planar induction coil may be configured to line the first cavity. The first planar induction coil may be arranged parallel to one or more of the first cavity, the first heating element, the first airflow channel and the second cavity.

One or both of the first heating element and the second heating element may be as susceptor. One or both of the first heating element and the second heating element may be a porous susceptor. One or both of the first heating element and the second heating element may be an induction heating element.

Power may be provided to the first planar induction coil. The first planar induction coil may be configured to heat at least a portion of the first heating element. The first planar induction coil may be configured to heat the first surface of the first heating element. The first planar induction coil may be configured to generate an alternating magnetic field penetrating at least a portion of the first heating element.

The first planar induction coil may be sealed. The first planar induction coil may be arranged in a device housing wall.

The heating arrangement may comprise a second planar induction coil. The second planar induction coil may be configured abutting the second cavity.

The second induction coil may have a rectangular cross-section. The second induction coil may be flat. The second induction coil may be cuboid-shaped.

The second planar induction coil may be configured to line the second cavity. The second planar induction coil may be arranged parallel to one or more of the first cavity, the first heating element, the first airflow channel, the second cavity and the first induction coil.

Power may be provided to the second planar induction coil. The second planar induction coil may be configured to heat at least a portion of the first heating element. The second planar induction coil may be configured to heat the second surface of the first heating element. The second planar induction coil may be configured to generate an alternating magnetic field penetrating at least a portion of the first heating element.

The second planar induction coil may be configured to heat at least a portion of the second heating element. The second planar induction coil may be configured to generate an alternating magnetic field penetrating at least a portion of the second heating element.

The second planar induction coil may be sealed. The second planar induction coil may be arranged in a device housing wall.

One or both of the first planar induction coil and the second planar induction coil may comprise shielding. The shielding may be an electromagnetic shielding. The electromagnetic shielding may at least partially shield the rest of the device from an electromagnetic field produced by the induction coil. The shielding may be thermal shielding. The thermal shielding may protect a user holding the device from being burnt by the heat produced by the heating element.

The device may comprise an intermediate section comprising the first cavity, the second cavity and the heating arrangement. The intermediate section may comprise a housing.

The device may comprise a mouthpiece. The mouthpiece may be removably mountable to the intermediate section.

The mouthpiece may comprise a housing. The mouthpiece may be removably mountable to the device. The mouthpiece may be fluidly connected with the first airflow channel via the first airflow channel open end. The mouthpiece may be fluidly connected with the second airflow channel via the second airflow channel open end. The mouthpiece may be fluidly connected with the first cavity via the first cavity open end. The mouthpiece may be in fluidly connected with the second cavity via the second cavity open end. The mouthpiece may comprise the aerosol outlet. The user may inhale aerosol through the aerosol outlet. The aerosol outlet may be fluidly connected with one or more of the first airflow channel, the first heating element, the first cavity, and the second cavity.

The mouthpiece may comprise a chamber. The chamber may be fluidly connected with one or more of the first airflow channel via the first airflow channel open end, the first heating element via the first airflow channel open end, the second airflow channel via the second airflow channel open end, the second heating element via the second airflow channel open end, the first cavity via the first cavity open end and the second cavity via the second cavity open end. The chamber may be fluidly connected with the aerosol outlet. Airflow from one or more of the first cavity, the second cavity, the first heating element and the first airflow channel may mix in the chamber. The mouthpiece may be arranged downstream of one or more of the first airflow channel, the first heating element, the first cavity, and the second cavity. The mouthpiece may be arranged at the mouth end. The mouthpiece may be arranged at the downstream end of the device. The mouthpiece may be a hinged mouthpiece. The chamber may be cooling chamber. One or both of volatized first-aerosol forming substrate and volatized second aerosol-forming substrate in an airflow entering the chamber may cool inside the chamber to form an aerosol. The chamber may be a mixing chamber. Airflow is from one or more of the first cavity, the second cavity, the first airflow channel and the first heating element may mix in the chamber. A homogenised mixture may be obtained.

The device may comprise a main body comprising one or more of a controller and a power supply. The mouthpiece may be removably mountable to the intermediate section.

The main body may comprise a controller. The main body may comprise a power supply. The power supply may be a battery. The main body may comprise one or more of the heating arrangement, the first cavity, the second cavity and the first airflow channel. Alternatively, one or more of the heating arrangement, the first cavity, the second cavity and the first airflow channel may be arranged the intermediate section. The main body may be configured to be removably attachable to the mouthpiece. The main body may comprise a housing.

The main body may comprise an interface. The interface may be configured as a data port for transferring data. The interface may be configured to connect to an external energy source for recharging the power supply.

The mouthpiece may be removed from the main body to insert one or more of the first aerosol-forming substrate, second aerosol-forming substrate, first aerosol-generating article and second aerosol-generating article.

The main body may be configured to be removably attached to an upstream end of the intermediate section. The intermediate section may be configured to be removably attached to an upstream end of the mouthpiece.

By providing the removably attachable mouthpiece, the removably attachable intermediate section and the removably attachable main body, the manufacturer may upgrade each part one at a time. By providing the removably attachable mouthpiece, the removably attachable intermediate section and the removably attachable main body, accessibility to one or both of the first cavity and the second cavity may be improved.

The device may comprise an air inlet. The device may comprise one or more of a first cavity inlet fluidly connecting the air inlet and the first cavity, a second cavity inlet fluidly connecting the air inlet and the second cavity, a first airflow channel inlet fluidly connecting the air inlet and the first porous heating element of the first airflow channel and a second airflow channel inlet fluidly connecting the air inlet and the second porous heating element of the second airflow channel.

The air inlet of the device may be an opening in a housing of the device. The device may comprise an airflow distribution channel arranged between the air inlet of the device and one or more of the first cavity inlet, second cavity inlet, first airflow channel inlet and second airflow channel inlet.

The first aerosol-forming substrate may be inserted into the first cavity via the first cavity inlet. The first aerosol-generating article may be inserted into the first cavity via the first cavity inlet. The second aerosol-forming substrate may be inserted into the second cavity via the second cavity inlet. The second aerosol-generating article may be inserted into the second cavity via the second cavity inlet.

The main body may have a length of between 30 millimeters and 70 millimeters. The main body may have a width of between 12 millimeters and 35 millimeters. The main body may have a height of between 5 millimeters and 15 millimeters.

The intermediate section may have a length of between 20 millimeters and 45 millimeters. The intermediate section may have a width of between 12 millimeters and 35 millimeters. The intermediate section may have a height of between 5 millimeters and 15 millimeters.

The mouthpiece may have a length of between 15 millimeters and 40 millimeters. The mouthpiece may have width of between 12 millimeters and 35 millimeters. The mouthpiece may have a height of between 5 millimeters and 15 millimeters.

One or both of the first cavity and the second cavity may have a length of between 10 millimeters and 30 millimeters. One both of the first cavity and the second cavity may have a width of between 7 millimeters and 17 millimeters. One or both of first cavity in the second cavity may have a height of between 1 millimeter and 5 millimeters.

The length of the heating element may be of between 10 millimeters and 30 millimeters, preferably of between 15 millimeters and 20 millimeters. The width of the heating element may be of between 7 millimeters and 17 millimeters, preferably of between 10 millimeters and 15 millimeters. The thickness of the heating element May be of between 1.5 millimeters and 5 millimeters, preferably of between 2 millimeters and 4 millimeters.

The length of the first portion of the heating element may be of between 5 millimeters and 20 millimeters, preferably of between 5 millimeters and 15 millimeters. The length of the second portion of the heating element may be of between 5 millimeters and 20 millimeters, preferably of between 5 millimeters and 15 millimeters. The thickness of the first portion of the heating element may be of between 0.35 millimeters and 2.5 millimeters, preferably of between 0.75 millimeters and 1.75 millimeters. The thickness of the second portion of the heating element may be of between 0.35 millimeters and 2.5 millimeters, preferably of between 0.75 millimeters and 1.75 millimeters.

In an optional embodiment, the device may comprise a first cavity configured for receiving a first aerosol-forming substrate and a heating arrangement comprising a first porous heating element. The first porous heating element may be arranged in a first airflow channel. The first porous heating element may be arranged abutting the first cavity. The first porous heating element may be fluidly connected with the first cavity.

The first cavity may be arranged between the first induction coil and the first airflow channel. The first cavity may be arranged abutting the first induction coil and the first airflow channel. The first heating element may be in contact with the first cavity.

In a further optional embodiment, the device may comprise the first resistive porous heating element and the second resistive porous heating element. The first heating element may be arranged in the first airflow channel. The second heating element may be arranged in the second airflow channel. The first cavity may be arranged between the first airflow channel and the second airflow channel. The first cavity may be arranged on a central longitudinal axis of the device. The first cavity may be configured to abut the first airflow channel and the second airflow channel. The first cavity may be configured to be fluidly connected to the first airflow channel and the second airflow channel.

In a further optional embodiment, the device may comprise the first induction coil arranged on a central longitudinal axis of the device. The device may comprise the first cavity and the second cavity. The first cavity may be configured to abut the first induction coil. The second cavity may be configured to abut the first induction coil. The first cavity may be arranged radially outward of first induction coil. The second cavity may be arranged radially outward of the first induction coil. The first induction coil may be arranged between the first cavity and the second cavity. The first airflow channel may be arranged abutting the first cavity. The second airflow channel may be arranged abutting the second cavity. The first cavity, the first induction coil, and the second cavity may be arranged between the first airflow channel and the second flow channel. The first cavity may be configured to be fluidly connected with the first airflow channel. The second cavity may be configured to be fluidly connected with the second airflow channel. The first porous heating element may be arranged in the first airflow channel. The second porous heating element may be arranged in the second airflow channel.

Characteristics discussed with respect to first heating element may correspondingly apply to the second heating element. The second heating element may have a first portion and a second portion as discussed above with respect to the first heating element. The second heating element may be produced by sintering as discussed above for the first heating element.

Characteristics discussed with respect to the first airflow channel may correspondingly apply to the second airflow channel.

In a second aspect of the invention, there is provided an aerosol-generating system comprising the aerosol-generating device as described herein and a first aerosol-forming substrate. The system may comprise a first planar aerosol-forming substrate.

In an embodiment of the invention, there is provided an aerosol-generating system, which may comprise the aerosol-generating device as described herein and a first aerosol-forming substrate.

The first aerosol-forming substrate may be a first planar aerosol-forming substrate.

A planar aerosol-forming substrate may be manufactured more efficiently. A planar aerosol-forming substrate may be compact. A planar aerosol-forming substrate may be heated with improved efficiency.

The first aerosol-forming substrate may be cuboid-shaped. The first aerosol-forming substrate may have a rectangular cross-section. The first aerosol-forming substrate may be flat. The first aerosol-forming substrate may be cylindrical. The first aerosol-forming substrate may have a flat cylindrical shape. The first aerosol-forming substrate may have an oval cross section. The first aerosol-forming substrate may be coin-shaped.

The first aerosol-forming substrate may be porous. The first aerosol-forming substrate may be configured to allow an airflow through the substrate.

As used herein, a “porous” element may be an element through which air can pass through when the pressure drop applied (resistance to draw) is in the range of between 80 to 130 mm H₂O.

The first aerosol-forming substrate may be configured to be slidable into the first cavity. The first aerosol-generating article may be configured to be slidable into the first cavity.

The system may comprise a second aerosol-forming substrate. The system may comprise a second planar aerosol-forming substrate.

The second aerosol-forming substrate may be cuboid-shaped. The second aerosol-forming substrate may have a rectangular cross-section. The second aerosol-forming substrate may be flat. The second aerosol-forming substrate may be cylindrical. The second aerosol-forming substrate may have a flat cylindrical shape. The second aerosol-forming substrate may have an oval cross section. The second aerosol-forming substrate may be coin-shaped.

The second aerosol-forming substrate may be porous. The second aerosol-forming substrate may be configured to allow an airflow through the substrate.

The second aerosol-forming substrate may be configured to be slidable into the second cavity. The second aerosol-generating article may be configured to be slidable into the second cavity.

The first aerosol-forming substrate may be configured to provide a first user experience. The second aerosol-forming substrate may be configured to provide a second user experience. The first user experience may be different to the second user experience.

Power may be provided to the first induction coil or the first resistive heating element to provide the first experience. A first heating profile may be provided to the first induction coil or the first resistive heating element. The first heating profile may be adapted to the characteristics of the first aerosol-forming substrate. Power may be provided to the second induction coil or the second resistive heating element to provide the second experience. A second heating profile may be provided to the second induction coil or the second resistive heating element. The second heating profile may be adapted to the characteristics of the second aerosol-forming substrate.

A third user experience may be provided by providing power to both the first induction coil and the second induction coil. A third user experience may be provided by providing power to both the first resistive heating element and the second resistive heating element. The third user experience may be a combination of the first user experience and the second user experience. The third user experience may be tuned by adapting one or both of the first heating profile and the second heating profile. The third user experience may be adapted to the individual preferences of the consumer.

The first aerosol-forming substrate may be configured to be different from the second aerosol-forming substrate. The first aerosol-generating article may be configured to be different from the second aerosol-generating article.

By providing differently shaped first substrate and second substrate, the user may readily distinguish between the first substrate and the second substrate. By providing differently shaped first article and second article, the user may readily distinguish between the first article and the second article. By providing differently shaped substrates and matching first cavity and second cavity, the risk of the consumer inserting the first substrate into the second cavity or inserting the second substrate into the first cavity may be reduced. By providing differently shaped articles and matching first cavity and second cavity, the risk of the consumer inserting the first article into the second cavity or inserting the second article into the first cavity may be reduced.

The first aerosol-forming substrate may be configured to be the same as the second aerosol-forming substrate. The first aerosol-generating article may be configured to be the same as the second aerosol-generating article.

The first aerosol-forming substrate may be shaped to closely conform to the shape of the first cavity. The second aerosol-forming substrate may be shaped to closely conform to the shape of the second cavity.

The first aerosol-forming substrate may form part of a first aerosol-generating article, The first aerosol-forming substrate may form part of the first planar aerosol-generating article. The second aerosol-forming substrate may form part of a second aerosol-generating article. The first aerosol-forming substrate may form part of a second planar aerosol-generating article. The first aerosol-generating article may be shaped to closely conform to the shape of the first cavity. The second aerosol-generating article may be shaped to closely conform to the shape of the second cavity.

By providing one or both of a substrate and an article that closely matches the cavity, heating efficiency may be improved. By providing one or both of a substrate and an article that closely matches the cavity, heat loss may be reduced.

The first aerosol-generating article may be cuboid-shaped. The first aerosol-generating article may have a rectangular cross-section. The first aerosol-generating article may be flat. The first aerosol-generating article may be cylindrical. The first aerosol-generating article may have a flat cylindrical shape. The first aerosol-generating article may have an oval cross section. The first aerosol-generating article may be coin-shaped. The first aerosol-generating article may be porous. The first aerosol-generating article may be configured to allow an airflow through the article.

The second aerosol-generating article may be cuboid-shaped. The second aerosol-generating article may have a rectangular cross-section. The second aerosol-generating article may be flat. The second aerosol-generating article may be cylindrical. The second aerosol-generating article may have a flat cylindrical shape. The second aerosol-generating article may have an oval cross section. The second aerosol-generating article may be coin-shaped. The second aerosol-generating article may be porous. The second aerosol-generating article may be configured to allow an airflow through the article.

An airflow through the first cavity may at least partially flow through an inserted first aerosol-generating article. An airflow through the first cavity may at least partially flow through an inserted first aerosol-forming substrate.

An airflow through the second cavity may at least partially flow through an inserted second aerosol-generating article. An airflow through the second cavity may at least partially flow through an inserted second aerosol-forming substrate.

The device may comprise a controller. The first induction coil may be connected to the controller. The second induction coil may be connected to the controller. The controller may be configured to control the operation of the first induction coil. The controller may be configured to control the operation of the second induction coil. The controller may be configured to control the first induction coil independently from the second induction coil. The controller may be configured to control a first power supply to the first induction coil. The controller may be configured to control a second power supply to the second induction coil. The first power supply may be different to the second power supply. The first power supply may be different to the second power supply in terms of one or more of intensity and timing. The controller may be configured to provide a first heating profile to the first induction coil. The controller may be configured to provide a second heating profile to the second induction coil. The first induction coil may be configured to heat at least a portion of the heating element. The second induction coil may be configured to heat at least a portion of the heating element. The heating profile provided by the first surface of the heating element may be different to the heating profile provided by the second surface of the heating element. The heating profile provided by the first portion of the heating element may be different to the heating profile provided by the second portion of the heating element.

The controller may be configured to provide power to the first resistive heating element. The controller may be configured to provide power to the second resistive heating element. The controller may be configured to provide power to the first resistive heating element independently from providing power to the second resistive heating element. The power provided to the first resistive heating element may be different to the power provided to the second resistive heating element. The controller may be configured to provide a first heating profile to the first resistive heating element. The controller may be configured to provide a second heating profile to the second resistive heating element. The first heating profile may be different to the second heating profile.

The first heating profile may be adapted to the characteristics of the first aerosol-forming substrate. The second heating profile may be adapted to the characteristics of the second-forming substrate.

The invention allows the user to flexibly adapt the user experience. For example, the user may insert a first aerosol-generating article comprising a first aerosol-forming substrate having particular first characteristics, such as first flavour or first nicotine content, if a user experience having such first characteristic is desired. Alternatively, the user may insert a second aerosol-generating article comprising a second aerosol-forming substrate having particular second characteristics, such as second flavour or second nicotine content, if the user experience having such second characteristics is desired. Alternatively, if the user desires a combination of the first characteristics and the second characteristics, the user may insert both the first aerosol-generating article and the second aerosol-generating article. The ratio between the first characteristics and the second characteristics may be adjusted by adapting the heating profile of the first heating element and the second heating element. For example, if a user experience having predominantly the first characteristic is desired, one or both of the intensity of the power supply and the length of this power supply to the first induction coil or the first portion of the resistive heating element may be increased, while one or both of the intensity of the power supply and the length of the power supply to the second induction coil or the second portion of the resistive heating element may be decreased.

In use, the user may insert one both of the first aerosol-forming substrate into the first cavity and the second aerosol-forming substrate into the second cavity. The user may draw on the mouthpiece of the device to pull in air through the air inlet. The airflow may be distributed between the first cavity via the first cavity inlet, the second cavity via the second cavity inlet and the first airflow channel via the first airflow inlet. At least a portion of the airflow through the first cavity may flow through the first aerosol-forming substrate, if the substrate is inserted into the first cavity. At least a portion of the airflow through the second cavity may flow through the second aerosol-forming substrate, if the substrate is inserted into the second cavity. The first heating element arranged in the first airflow channel may heat and volatize at least a portion of one or both of first aerosol-forming substrate and the second aerosol forming substrate depending on the desired user experience.

At least a portion of the volatized first aerosol-forming substrate may flow into the first heating element via a porous surface of the porous heating element. At least a portion of the volatized second aerosol-forming substrate may flow into the first heating element via a porous surface of the porous heating element. The volatized first aerosol-forming substrate and second aerosol-forming substrate flowing into first heating element may mix in the first airflow channel with the airflow through the first airflow channel inlet. Such mixture may flow through the first porous heating element into the chamber of the mouthpiece via the first airflow channel open end.

At least a portion of the volatized first aerosol-forming substrate may flow into the chamber of the mouthpiece via the first cavity open end. At least a portion of the volatized second aerosol-forming substrate may flow into the chamber of the mouthpiece via second cavity open end.

The airflows from the first cavity, the second cavity and the first airflow channel may mix in the chamber of the mouthpiece. The mixture may cool, such that an aerosol is formed. The user may inhale the aerosol through the aerosol outlet of the mouthpiece.

One or both of the mouthpiece and the main body may be made from a polymeric material.

A longitudinal axis of a component may be an axis along or parallel to the lengthwise direction of the component.

As used herein, the terms ‘proximal’, ‘distal’, ‘downstream’ and ‘upstream’ are used to describe the relative positions of components, or portions of components, of the aerosol-generating device in relation to the direction in which a user draws on the aerosol-generating device during use thereof.

The aerosol-generating device may comprise a mouth end through which in use an aerosol exits the aerosol-generating device and is delivered to a user. The mouth end may also be referred to as the proximal end. In use, a user draws on the proximal or mouth end of the aerosol-generating device in order to inhale an aerosol generated by the aerosol-generating device. The aerosol-generating device comprises a distal end opposed to the proximal or mouth end. The proximal or mouth end of the aerosol-generating device may also be referred to as the downstream end and the distal end of the aerosol-generating device may also be referred to as the upstream end. Components, or portions of components, of the aerosol-generating device may be described as being upstream or downstream of one another based on their relative positions between the proximal, downstream or mouth end and the distal or upstream end of the aerosol-generating device.

The second portion of the first porous heating element being arranged proximal to the first portion of the first porous heating element may refer to the relative position of the second portion of the first porous heating element and the first portion of the first porous heating element in relation to the direction in which a user draws on the aerosol-generating device during use thereof.

A first component being arranged proximal to a second component may refer to the first component being arranged at an end of the second component facing a mouth end of the device. A first portion of a component being arranged proximal to a second portion of the component may refer to the first portion of the component being arranged at an end of the second portion of the component facing a mouth end of the device.

A first component being arranged proximal to a second component may refer to the first component abutting an end of the second component facing a mouth end of the device. A first portion of a component being arranged proximal to a second portion of the component may refer to the first portion of the component abutting at an end of the second portion of the component facing a mouth end of the device.

A first component being arranged proximal to a second component may refer to the first component being arranged at a proximal end of the second component. A first portion of a component being arranged proximal to a second portion of the component may refer to the first portion of the component being arranged at a proximal end of the second portion of the component. A proximal end of a component may be an end of the component arranged towards the mouth end of the device. A proximal end of a portion of a component may be an end of the portion of the component arranged towards the mouth end of the device.

As used herein, an ‘aerosol-generating device’ relates to a device that interacts with an aerosol-forming substrate to generate an aerosol. The aerosol-forming substrate may be part of an aerosol-generating article, for example part of a smoking article. An aerosol-generating device may be a smoking device that interacts with an aerosol-forming substrate of an aerosol-generating article to generate an aerosol that is directly inhalable into a user's lungs thorough the user's mouth. An aerosol-generating device may be a holder. The device may be an electrically heated smoking device. The aerosol-generating device may comprise a housing, electric circuitry, a power supply and a heating arrangement.

As used herein with reference to the present invention, the term ‘smoking’ with reference to a device, article, system, substrate, or otherwise does not refer to conventional smoking in which an aerosol-forming substrate is fully or at least partially combusted. The aerosol-generating device of the present invention is arranged to heat the aerosol-forming substrate to a temperature below a combustion temperature of the aerosol-forming substrate, but at or above a temperature at which one or more volatile compounds of the aerosol-forming substrate are released to form an inhalable aerosol.

The aerosol-generating device may comprise electric circuitry. The electric circuitry may comprise a microprocessor, which may be a programmable microprocessor. The microprocessor may be part of a controller. The electric circuitry may comprise further electronic components. The electric circuitry may be configured to regulate a supply of power to the heating arrangement. Power may be supplied to the heating arrangement continuously following activation of the aerosol-generating device or may be supplied intermittently, such as on a puff-by-puff basis. The power may be supplied to the heating arrangement in the form of pulses of electrical current. The electric circuitry may be configured to monitor the electrical resistance of the heating element, and preferably to control the supply of power to the heating element dependent on the electrical resistance of the heating element.

The aerosol-generating device may comprise a power supply, typically a battery, within the main body of the aerosol-generating device. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery. The power supply may be a Lithium-ion polymer battery. As an alternative, the power supply may be another form of charge storage device such as a capacitor. The power supply may be a super-capacitor. The power supply may be a hyper-capacitor. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the heating element.

The first cavity open end may be a proximal end. The second cavity open end may be a proximal end. The first cavity may comprise a base opposite to the first cavity open end. The second cavity may comprise a base opposite to the second cavity open end. The first cavity base may be closed except for the provision of the first cavity inlet arranged at the base. The second cavity base may be closed except for the provision of the second cavity inlet arranged at the base. The first cavity base may be flat. The second cavity base may be flat. The first cavity base may be rectangular. The second cavity base may be rectangular. The first cavity base may be arranged upstream of the first cavity. The second cavity base may be arranged upstream of the second cavity. The first cavity open end may be arranged downstream of the first cavity. The second cavity open end may be arranged downstream of the second cavity. The first cavity may have an elongate extension. The second cavity may have an elongate extension. The first cavity may have a longitudinal central axis. The second cavity may have a longitudinal central axis.

The first airflow channel open end may be a proximal end. The airflow channel cavity open end may be a proximal end. The first airflow channel may comprise a base opposite to the first airflow channel open end. The second airflow channel may comprise a base opposite to the second airflow channel open end. The first airflow channel base may be closed except for the provision of the first airflow channel inlet arranged at the base. The second airflow channel base may be closed except for the provision of the second airflow channel inlet arranged at the base. The first airflow channel base may be flat. The second airflow channel base may be flat. The first airflow channel base may be rectangular. The second airflow channel base may be rectangular. The first airflow channel base may be arranged upstream of the first airflow channel. The second airflow channel base may be arranged upstream of the second airflow channel. The first airflow channel open end may be arranged downstream of the first airflow channel. The second airflow channel open end may be arranged downstream of the second airflow channel. The first airflow channel may have an elongate extension. The second airflow channel may have an elongate extension. The first airflow channel may have a longitudinal central axis. The second airflow channel may have a longitudinal central axis.

The first cavity may be configured as a heating chamber. The second cavity may be configured as a heating chamber. The first cavity may have a hollow rectangular shape. The second cavity may have a hollow rectangular shape. The first cavity may have a shape corresponding to the shape of the first aerosol-generating article to be received in the first cavity. The second cavity may have a shape corresponding to the shape of the second aerosol-generating article to be received in the second cavity. The first cavity may have an inner diameter corresponding to the outer diameter of the first aerosol-generating article. The first cavity may have an inner diameter corresponding to the outer diameter of the first aerosol-forming substrate. The second cavity may have an inner diameter corresponding to the outer diameter of the second aerosol-generating article. The second cavity may have an inner diameter corresponding to the outer diameter of the second aerosol-forming substrate.

The heating arrangement may be a resistive heating arrangement. The heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum platinum, gold and silver. Examples of suitable metal alloys include stainless steel, nickel-, cobalt-, chromium-, aluminium-titanium-zirconium-, hafnium-, niobium-, molybdenum-, tantalum-, tungsten-, tin-, gallium-, manganese-, gold-and iron-containing alloys, and super-alloys based on nickel, iron, cobalt, stainless steel, Timetal® and iron-manganese-aluminium based alloys. In composite materials, the electrically resistive material may optionally be embedded in, encapsulated or coated with an insulating material or vice-versa, depending on the kinetics of energy transfer and the external physicochemical properties required.

The heating arrangement may be an induction heating arrangement. The induction heating arrangement may comprise the first induction coil and the heating element. The induction heating arrangement may comprise the second induction coil and the heating element. The induction heating arrangement may comprise the first induction coil, the second induction coil and the first heating element. The induction heating arrangement may comprise the first induction coil, the second induction coil and the first heating element and the second heating element.

The heating element may be a susceptor. The heating element may be a material that is capable of generating heat, when penetrated by an alternating magnetic field. The first induction coil may generate an alternating magnetic field in the first cavity. The first induction coil may generate an alternating magnetic field penetrating at least a portion of the heating element. The second induction coil may generate an alternating magnetic field in the second cavity. The second induction coil may generate an alternating magnetic field penetrating at least a portion of the second heating element.

If the heating element is conductive, then typically eddy currents are induced by the alternating magnetic field. If the heating element is magnetic, then typically another effect that contributes to the heating is commonly referred to hysteresis losses. Hysteresis losses occur mainly due to the movement of the magnetic domain blocks within the heating element, because the magnetic orientation of these will align with the magnetic induction field, which alternates. Another effect contributing to the hysteresis loss is when the magnetic domains will grow or shrink within the heating element. Commonly all these changes in the heating element that happen on a nano-scale or below are referred to as “hysteresis losses”, because they produce heat in the heating element. Hence, if the one or both of the first in element and the second heating element is both magnetic and electrically conductive, both hysteresis losses and the generation of eddy currents will contribute to the heating of the one or both of the first heating element and the second heating element. If the heating element is magnetic, but not conductive, then hysteresis losses will be the only means by which the heating element will heat, when penetrated by an alternating magnetic field. According to the invention, the heating element may be electrically conductive or magnetic or both electrically conductive and magnetic. An alternating magnetic field generated by the first induction coil may heat at least a portion the heating element abutting the first cavity, which then transfers the heat to the first aerosol-forming substrate. An alternating magnetic field generated by the second induction coil may heat at least a portion of the second heating element, which then transfers the heat to the second aerosol-forming substrate. The heat transfer may be mainly by conduction of heat. Such a transfer of heat is best, if the portion of the heating element is in close thermal contact with the aerosol-forming substrate.

As used herein, the term ‘aerosol-generating article’ refers to an article comprising an aerosol-forming substrate that is capable of releasing volatile compounds that can form an aerosol. For example, an aerosol-generating article may be a smoking article that generates an aerosol that is directly inhalable into a user's lungs through the user's mouth. An aerosol-generating article may be disposable.

As used herein, the term ‘aerosol-forming substrate’ relates to a substrate capable of releasing one or more volatile compounds that can form an aerosol. Such volatile compounds may be released by heating the aerosol-forming substrate. An aerosol-forming substrate may conveniently be part of an aerosol-generating article or smoking article.

The aerosol-forming substrate may be a solid aerosol-forming substrate. The aerosol-forming substrate may comprise both solid and liquid components. The aerosol-forming substrate may comprise a tobacco-containing material containing volatile tobacco flavour compounds which are released from the substrate upon heating. The aerosol-forming substrate may comprise nicotine. The aerosol-forming substrate may comprise a non-tobacco material. The aerosol-forming substrate may comprise an aerosol former that facilitates the formation of a dense and stable aerosol. Examples of suitable aerosol formers are glycerine and propylene glycol. The aerosol-forming substrate may be a liquid aerosol-forming substrate. The aerosol-forming substrate may comprise flavouring. The aerosol-forming substrate may comprise botanicals. The aerosol-forming substrate may comprise cannabis for therapeutic use.

The invention is defined in the claims. However, below there is provided a non-exhaustive list of non-limiting examples. Any one or more of the features of these examples may be combined with any one or more features of another example, embodiment, or aspect described herein.

Example 1: An aerosol-generating device comprising a first cavity configured for receiving a first aerosol-forming substrate, a second cavity configured for receiving a second aerosol-forming substrate, a heating arrangement comprising a first porous heating element, wherein the first porous heating element is arranged in a first airflow channel between the first cavity and the second cavity, wherein the first porous heating element is arranged abutting the first cavity and the second cavity, wherein the first porous heating element is fluidly connected with one or both of the first cavity and the second cavity.

Example 2: The aerosol-generating device according to example 1, wherein the first porous heating element has a sponge-like structure or a foam-like structure.

Example 3: The aerosol-generating device according to any of the preceding examples, wherein the first porous heating element is planar.

Example 4: The aerosol-generating device according to any of the preceding examples, wherein the first porous heating element comprises a first portion and a second portion.

Example 5: The aerosol-generating device according to example 4, wherein the first portion of the first porous heating element comprises a first porosity, and wherein the second portion of the first porous heating element comprises a second porosity.

Example 6: The aerosol-generating device according to any of examples 4 and 5, wherein the first portion of the first porous heating element is made from a first material and the second portion of the first porous heating element is made from a second material.

Example 7: The aerosol-generating device according to any of examples 4 to 6, wherein the first portion of the first porous heating element is configured abutting the second portion of the first porous heating element.

Example 8: The aerosol-generating device according to any of examples 4 to 7, wherein the second portion of the first porous heating element is arranged proximal to the first portion of the first porous heating element.

Example 9: The aerosol-generating device according to example 8, wherein the first portion of the first porous heating element and the second portion of the first porous heating element are arranged abutting the first cavity and the second cavity.

Example 10: The aerosol-generating device according to any of examples 4 to 7, wherein the first portion of the first porous heating element and the second portion of the first porous heating element are arranged parallel to each other.

Example 11: The aerosol-generating device according to example 10, wherein the first portion of the first porous heating element is arranged abutting the first cavity, and wherein the second portion of the first porous heating element is arranged abutting the second cavity.

Example 12: The aerosol-generating device according to any of the preceding examples, wherein the first porous heating element is produced by sintering.

Example 13: The aerosol-generating device according to any of the preceding examples, wherein the first porous heating element comprises a first surface configured abutting the first cavity and a second surface configured abutting the second cavity, preferably wherein the first surface and the second surface are configured to be smooth.

Example 14: The aerosol-generating device according to any of the preceding examples, wherein the device comprises an aerosol outlet, wherein the first porous heating element is configured to fluidly connect one or both of the first cavity and the second cavity with the aerosol outlet.

Example 15: The aerosol-generating device according to any of the preceding examples, wherein one or both of the first cavity and the second cavity are planar.

Example 16: The aerosol-generating device according to any of the preceding examples, wherein the first porous heating element is a resistive heating element.

Example 17: The aerosol-generating device according to any of examples 1 to 15, wherein the heating arrangement comprises a first planar induction coil, wherein the first planar induction coil is configured abutting the first cavity.

Example 18: The aerosol-generating device according to any of examples 1 to 15 and 17, wherein the heating arrangement comprises a second planar induction coil, wherein the second planar induction coil is configured abutting the second cavity.

Example 19: The aerosol-generating device according to any of the preceding examples, wherein the device comprises an intermediate section comprising the first cavity, the second cavity and the heating arrangement.

Example 20: The aerosol-generating device according to any of the preceding examples, wherein the device comprises a mouthpiece, preferably wherein the mouthpiece is removably mountable to the intermediate section of example 19.

Example 21: The aerosol-generating device according to any of the preceding examples, wherein the device comprises a main body comprising one or more of a controller and a power supply, preferably wherein the mouthpiece is removably mountable to the

Example 22: The aerosol-generating device according to any of the preceding examples, wherein the device comprises an air inlet, wherein the device comprises one or more of a first cavity inlet fluidly connecting the air inlet and the first cavity, a second cavity inlet fluidly connecting the air inlet and the second cavity, and an airflow channel inlet fluidly connecting the air inlet and the first porous heating element.

Example 23: An aerosol-generating system comprising the aerosol-generating device according to any of examples 1 to 22, wherein the system comprises a first aerosol-forming substrate, preferably a first planar aerosol-forming substrate.

Example 24: The aerosol-generating system according to example 23, wherein the first aerosol-forming substrate is porous.

Example 25: The aerosol-generating system according to any of examples 23 and 24, wherein the system comprises a second aerosol-forming substrate, preferably a second planar aerosol-forming substrate.

Example 26: The aerosol-generating system according to any of examples 23 to 25, wherein the second aerosol-forming substrate is porous.

Example 27: The aerosol-generating system according to any of examples 23 to 26, wherein the first aerosol-forming substrate is configured to be different from the second aerosol-forming substrate.

Example 28: The aerosol-generating system according to any of examples 23 to 26, wherein the first aerosol-forming substrate is configured to be the same as the second aerosol-forming substrate.

Example 29: The aerosol-generating system according to any of examples 23 to 28, wherein the first aerosol-forming substrate is shaped to closely conform to the shape of the first cavity and wherein the second aerosol-forming substrate is shaped to closely conform to the shape of the second cavity.

Example 30: The aerosol-generating system according to any of examples 23 to 29, wherein the first aerosol-forming substrate forms part of a first aerosol-generating article, preferably wherein the first planar aerosol-generating article and wherein the second aerosol-forming substrate forms part of a second aerosol-generating article, preferably a second planar aerosol-generating article, preferably wherein the first aerosol-generating article is shaped to closely conform to the shape of the first cavity and wherein the second aerosol-generating article is shaped to closely conform to the shape of the second cavity.

Below, there is provided a non-exhaustive list of non-limiting examples. Any one or more of the features of these examples may be combined with any one or more features of another example, embodiment, or aspect described herein.

Features described in relation to one embodiment may equally be applied to other embodiments of the invention.

The invention will be further described, by way of example only, with reference to the accompanying drawings in which:

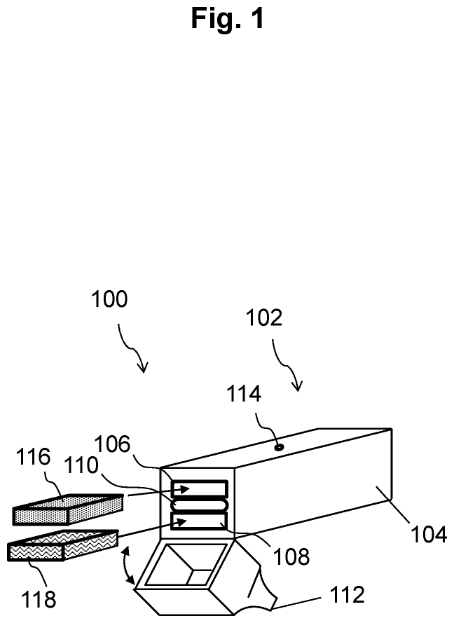

FIG. 1 shows an aerosol generating system of the invention;

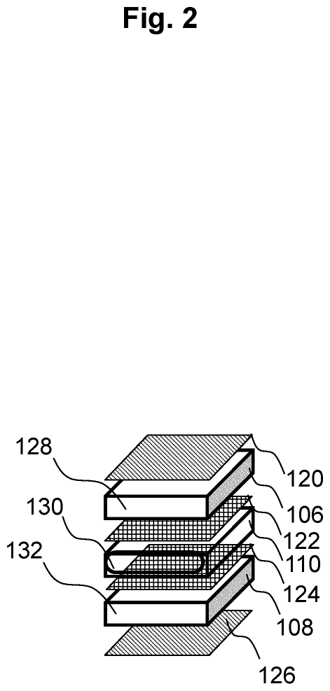

FIG. 2 shows a layered view of components of the aerosol-generating system of the invention;

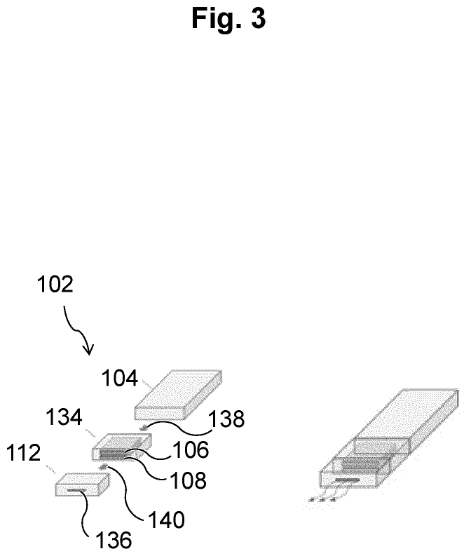

FIG. 3 shows a simplified view of a modular aerosol-generating device in a disassembled state (left-hand side) and an assembled state (right-hand side);

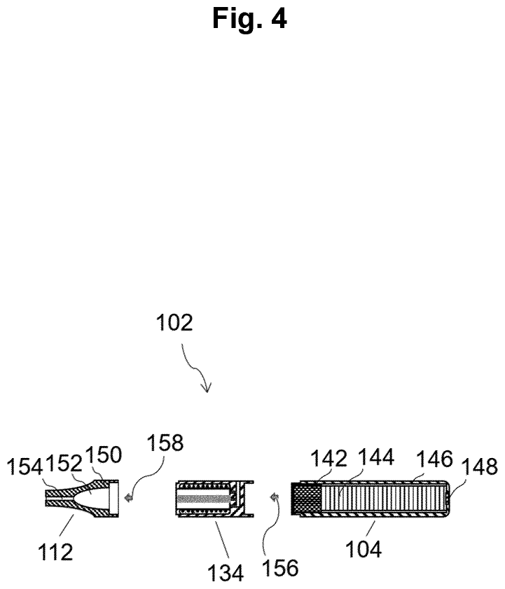

FIG. 4 shows a modular aerosol-generating device in a disassembled state;

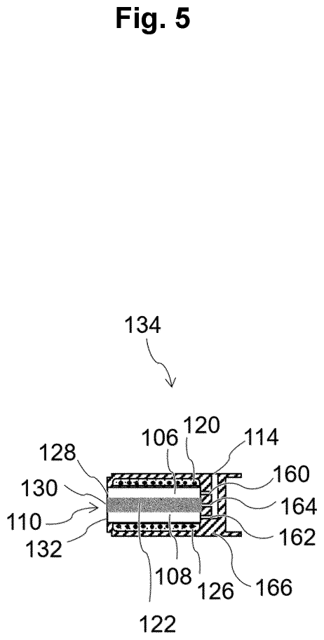

FIG. 5 shows details of the intermediate section of FIG. 4;

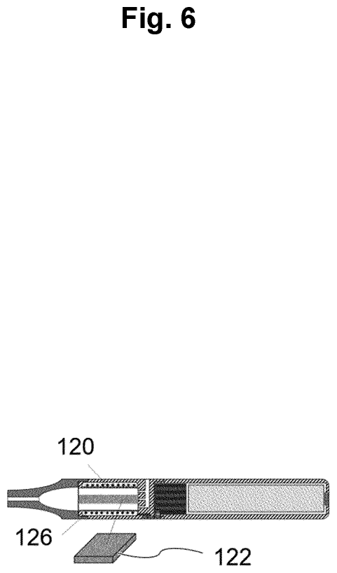

FIG. 6 shows the modular aerosol-generating device of FIG. 4 in an assembled state;

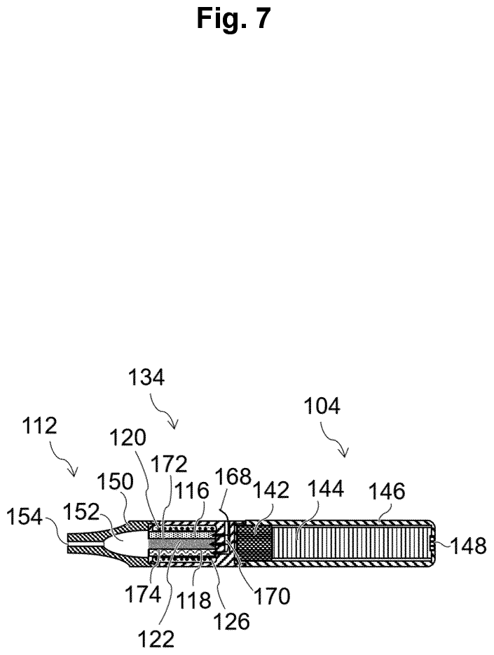

FIG. 7 shows an embodiment of the aerosol-generating system of the invention;

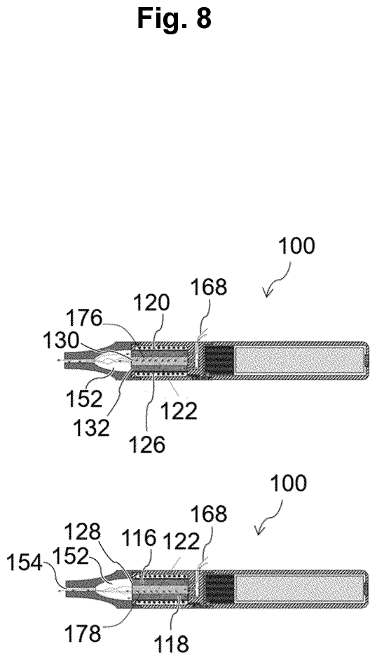

FIG. 8 shows two modes of operation of the aerosol-generating system;

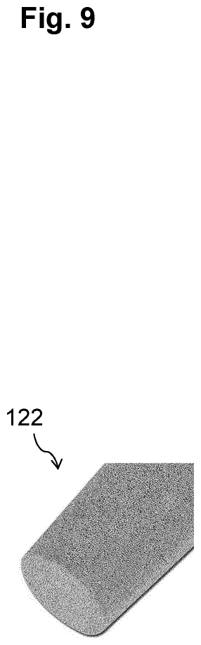

FIG. 9 shows a cylindrical first porous heating element;

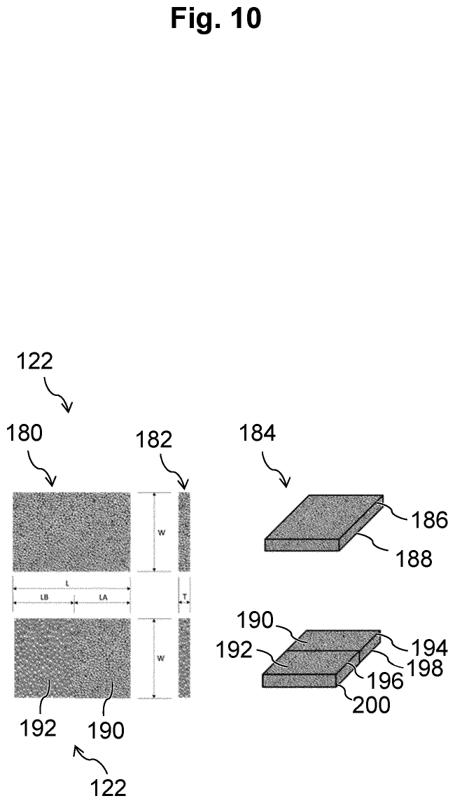

FIG. 10 shows two different planar first porous heating elements;

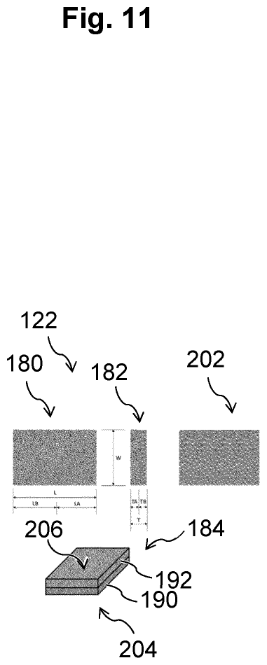

FIG. 11 shows a planar first porous heating element.

FIG. 1 shows a simplified illustration of an aerosol-generating system 100. System 100 comprises an aerosol-generating device 102. Device 102 comprises a main body 104. Device 102 comprises a first cavity 106. Device 102 comprises a second cavity 108. Device 102 comprises a first airflow channel 110. Device 102 comprises a mouthpiece 112. Device 102 comprises an air inlet 114.

First cavity 106 abuts first airflow channel 110. Second cavity 108 abuts first airflow channel 110. First airflow channel 110 is arranged between first cavity 106 and second cavity 108.

System 100 comprises a first aerosol-generating article 116 comprising a first aerosol forming substrate. System 100 comprises a second aerosol-generating article 118 comprising a second aerosol-forming substrate. First aerosol-generating article 116 may be different to second aerosol-generating article 118. For example, first aerosol-generating article 116 may comprise a different aerosol-forming substrate than the second aerosol-generating article 118. First aerosol-generating article 116 may be inserted into first cavity 106 as indicated by an arrow. Second aerosol-generating article 118 may be inserted into second cavity 108 as indicated by an arrow.

Mouthpiece 112 is a hinged mouthpiece. Mouthpiece 112 may be moved between a first position and a second position. FIG. 1 shows the first position of mouthpiece 112, in which mouthpiece 112 is arranged to allow aerosol-generating articles to be inserted into the device 102. Once one or both of first aerosol-generating article 116 and second aerosol-generating article 118 is inserted into device 102, mouthpiece 112 may be moved into the second position in which mouthpiece 112 engages with the downstream end of aerosol-generating device 102.

In the second position, mouthpiece 112 abuts the downstream end of main body 104 of device 102. In the second position, mouthpiece 112 is in fluid communication with first cavity 106, second cavity 108, and first airflow channel 110.

Device 102 comprises a first porous heating element (not shown) arranged in first airflow channel 110.

In use, the user may draw on mouthpiece 112 to draw air into air inlet 114. The drawn air may be distributed between first cavity 106, second cavity 108, and airflow channel 110. The airflow through first cavity 106 may at least partially enter first aerosol-generating article 116. The airflow through the second cavity 108 may at least partially enter second aerosol-generating article 118. The first porous heating element may heat the inserted first aerosol-forming substrate. The first porous heating element may at least partially volatize the first aerosol-forming substrate. Additionally or alternatively, the first porous heating element may heat the inserted second aerosol-forming substrate. The first porous heating element may at least partially volatize the inserted second aerosol-forming substrate.

Volatized first aerosol-forming substrate may flow radially inward into first airflow channel 110 and the first porous heating element. Volatized first aerosol-forming substrate may directly flow into mouthpiece 112. Volatized second aerosol-forming substrate may flow radially inward into the first airflow channel 110 and the first porous heating element. Volatized second aerosol-forming substrate may directly flow into mouthpiece 112. Volatized first aerosol-forming substrate and volatized second-aerosol forming substrate mix in first airflow channel 110 and first porous heating element with air directly drawn into first airflow channel 110 through air inlet 114. Such mixture may flow from first airflow channel 110 into mouthpiece 112. Aerosol may be inhaled through mouthpiece 112.

FIG. 2 shows a staggered view of an arrangement of components of the invention. The components form a stack which may be included in an intermediate section or main body 104 of aerosol-generating device 112. The stack comprises, from top to bottom, a first planar induction coil 120, first planar cavity 106, a planar first porous induction heating element 122, first planar airflow channel 110, a planar second porous induction heating element 124, second planar cavity 108 and a second planar induction coil 126.

First cavity 106 comprises an open end 128. Airflow channel 110 comprises an open end 130. Second cavity 108 comprises an open end 132. First cavity 106 may be fluidly connected with mouthpiece 112 via open end 128 of first cavity 106. Second cavity 108 may be fluidly connected with mouthpiece 112 via open end 132 of second cavity 108. First airflow channel 110 may be fluidly connected with mouthpiece 112 via open end 130 of the first airflow channel 110.

FIG. 3 shows a simplified view of a modular aerosol-generating device 102 in a disassembled state (left-hand side) and an assembled state (right-hand side). Device 102 comprises main body 104. Device 102 comprises an intermediate section 134. Device 102 comprises mouthpiece 112.

Main body 104 comprises a controller (not shown). Main body 104 comprises a power supply (not shown). Intermediate section 134 comprises first cavity 106, second cavity 18, first airflow channel 110 and the first porous heating element (not shown). The mouthpiece comprises an aerosol outlet 136.

Main body 104 is configured to be mountable to an upstream end of intermediate section 134. Intermediate section 134 is configured to be mountable to an upstream end of mouthpiece 112. Main body 104 may be mounted to intermediate section 134 as indicated by arrow 138. Intermediate section 134 may be mounted to mouthpiece 112 as indicated by arrow 140. The assembled device 102 is shown on the right-hand side of FIG. 3, in which main body 104 is mounted to intermediate section 134 and intermediate section 134 is mounted to mouthpiece 112. The arrows at aerosol outlet 136 indicate the flow of aerosol out of the aerosol outlet into the user's mouth when a user inhales on aerosol outlet 136.

First aerosol-generating article 116 may be inserted into first cavity 106 when mouthpiece 112 is not mounted at intermediate section 134. Second aerosol-generating article 118 may be inserted into second cavity 108 when mouthpiece 112 is not mounted at intermediate section 134.

FIG. 4 shows a modular aerosol-generating device 102 in a disassembled state. Device 102 comprises main body 104. Device 102 comprises mouthpiece 112. Device 102 comprises intermediate section 134.

Main body 102 comprises a controller 142. Main body 102 comprises a power supply 144. Controller 142 may be configured to supply intermediate section 134 with power from power supply 144. Main body 102 comprises a housing 146. Main body 102 comprises an interface 148 which may be a data port or an interface for connecting an external energy source to recharge power supply 144.

Mouthpiece 112 comprises a housing 150. Mouthpiece 112 comprises a chamber 152. Mouthpiece 112 comprises an aerosol outlet 154.

Aerosol-generating device 102 is shown to be disassembled. Main body 104 may be removably connected to an upstream end of intermediate section 134 as indicated by arrow 156. Intermediate section 134 may be removably connected to an upstream end of mouthpiece 112 as indicated by arrow 158. The details of intermediate section 134 are shown in FIG. 5.

FIG. 5 shows the details of intermediate section 134 of FIG. 4. Intermediate section 134 comprises first planar heating coil 120. Intermediate section 134 comprises second planar heating coil 126. Intermediate section 134 comprises first planar cavity 106. Intermediate section 134 comprises second planar cavity 108. Intermediate section 134 comprises first porous heating element 122. First porous heating element 122 is planar. First porous heating element 122 is an induction heating element. Intermediate section 134 comprises airflow channel 110. First porous heating element 122 is arranged in airflow channel 110.

First cavity 106 comprises open end 128. Second cavity 108 comprises open end 132. First airflow channel 110 comprises open end 130.

Intermediate section 134 comprises air inlet 114. Intermediate section 134 comprises a first cavity inlet 160. Intermediate section 134 comprises a second cavity inlet 162. Intermediate section 134 comprises a first airflow channel inlet 164. Intermediate section 134 comprises a housing 166. Air inlet 114 may be arranged in housing 166.

In use, first aerosol-generating article 116 comprising a first aerosol-forming substrate may be inserted into first cavity 106. Additionally or alternatively, second aerosol-generating article 118 comprising a second aerosol-forming substrate may be inserted into second cavity 108. Main body 104 may be connected to intermediate section 134 and intermediate section 134 may be connected to mouthpiece 112 to obtain an assembled aerosol-generating system.

In use, a user may draw on aerosol outlet 154 of mouthpiece 112, such that air enters air inlet 114. The airflow through air inlet 114 may be distributed between first cavity inlet 160, second cavity inlet 162, and first airflow channel inlet 164.

The airflow through first cavity inlet 160 enters first cavity 106. The airflow through second cavity inlet 162 enters second cavity 108. The airflow through first airflow channel inlet 164 enters first airflow channel 110.

A portion of the airflow through first cavity 106 enters first airflow channel 110 and first porous heating element 122. A portion of the airflow through first cavity 106 enters mouthpiece 112 via open end 128.

A portion of the airflow through second cavity 108 enters the first airflow channel 110 and first porous heating element 122. A portion of the airflow through second cavity 108 enters mouthpiece 112 via open end 132.

The airflow through air flow channel 110 and first porous heating element 122 enters mouthpiece 112 through open end 130.

FIG. 6 shows the modular aerosol-generating device 102 of FIG. 4 in an assembled state. Main body 104 is attached to an upstream end of intermediate section 134. Intermediate section 134 is attached to an upstream end of mouthpiece 104.

FIG. 6 further shows a three-dimensional view of planar first porous heating element 122.

FIG. 7 shows an embodiment of aerosol-generating system 100 of the invention. System 100 comprises aerosol-generating device 102. The remarks relating to device 102 of FIGS. 4 to 6 apply, mutatis mutandis, to device 102 shown in FIG. 7.

System 100 comprises first aerosol-generating article 116 comprising a first aerosol-forming substrate. System 100 comprises second aerosol-generating article 118 comprising a second aerosol-forming substrate. First aerosol-generating article 116 is shown to be inserted into first cavity 106. Second aerosol-generating article 118 is shown to be inserted into second cavity 108.

In use, the user draws on aerosol outlet 154 mouthpiece 112 to pull in air through air inlet 114 as indicated by arrow 168. The airflow through air inlet 114 enters airflow distribution channel 170. The airflow is distributed between the first cavity inlet 160, the second cavity inlet 162, and the first airflow channel inlet 164. At least a portion of the airflow through first cavity inlet 160 enters the first aerosol-generating article 116. At least a portion of the airflow through second cavity inlet 162 enters the second aerosol-generating article 118. At least a portion of the airflow through first airflow channel inlet 164 enters first porous heating element 122.

Power may be provided by the controller 142 to the first induction coil 120. First induction coil 120 may generate an alternating magnetic field penetrating a first surface 172 of first porous heating element 122. First induction coil 120 may heat first surface 172 of first porous heating element 122. First surface 172 is a first heating surface. First surface 172 is in contact with first cavity 106. First surface 172 is in contact with aerosol-generating article 116. First surface 172 may heat the first aerosol-forming substrate to volatize at least a portion of the first aerosol-forming substrate.

Power may be provided to by controller 142 to second induction heating coil 126. Second induction heating coil 126 may generate in alternating magnetic field penetrating a second surface 174 of first porous heating element 122. Second induction coil 126 may heat second surface 174 of the first porous heating element 122. Second surface 174 is a second heating surface. Second surface 174 is in contact with second cavity 108. Second surface 174 is in contact with second aerosol-generating article 118. Second surface 172 may heat the second aerosol-forming substrate to volatize at least a portion of second first aerosol-forming substrate.

First surface 172 may configured to provide a different heating profile than second surface 174. First surface 172 may have one or both of a different porosity and a different material than second surface 174.

Power may be provided to first induction coil 120 independently of power being provided to second induction coil 126. Power may be provided to second induction coil 126 independently of power being provided to first induction coil 120.

Volatized first aerosol-forming substrate may flow from first cavity 106 into first porous heating element 122 through porous first surface 172 of heating element 122. Volatized second aerosol-forming substrate may flow from second cavity 108 into first porous heating element 122 through porous second surface 174 of heating element 122.

Volatized first aerosol-forming substrate may flow from first cavity 106 into chamber 152 of mouthpiece 112 via open end 128. Volatized second aerosol-forming substrate may flow from second cavity 108 into chamber 152 of mouthpiece 112 via open end 132. The mixture of one or both of first aerosol-forming substrate and second aerosol-forming substrate entering porous heating element 122 and the airflow through first airflow channel inlet 164 may flow into chamber 152 of mouthpiece 112 via open end 130.

The airflow from first airflow channel 110, first cavity 106 and second cavity 108 mix in the chamber 152. The mixing may improve aerosol quality. The mixing may improve homogeneity of the aerosol. The mixture may cool in chamber 152 to form an aerosol. The consumer may inhale the aerosol through aerosol outlet 148.

FIG. 8 shows two modes of operation of aerosol-generating system 100 of FIG. 7. In the top drawing of system 100, system 100 is shown with only first induction coil 120 in operation. As only first induction coil 120 is in operation, only first surface 172 of first porous heating element 122 is heated. First surface 172 heats first aerosol-forming substrate arranged in first cavity 106 to volatize at least a portion of the first aerosol-forming substrate.

At least a portion of the volatized first aerosol-forming substrate is pulled through first aerosol-generating article 116 by the airflow entering first cavity 16 via first cavity inlet 160. At least a portion of the volatized first aerosol-forming substrate flows from the first cavity 106 into first porous heating element 122 via porous first surface 172 as indicated by the diagonal arrows 176. The portion of volatized first aerosol forming substrate flowing into first airflow channel 110 and the airflow entering first airflow channel 110 via first airflow inlet 164 mix in first airflow channel 110. Such mixture flows into chamber 152 via open and 130 of first airflow channel 110. At least a portion of volatized first aerosol-forming substrate flows into chamber 152 of mouthpiece 112 via open and 128 of first cavity 106. The different airflows entering chamber 152 mix in chamber 152. The airflows entering chamber 152 may cool in chamber 152, such that an aerosol is formed. The aerosol is inhaled through aerosol outlet 152.

In the bottom drawing of system 100, system 100 is shown with only second induction coil 120 in operation. As only second induction coil 120 is in operation, only second surface 174 of first porous heating element 122 is heated. Second surface 174 heats the second aerosol-forming substrate arranged in second cavity 106 to volatize at least a portion of the second aerosol-forming substrate.

At least a portion of the volatized second aerosol-forming substrate is pulled through second aerosol-generating article 118 by the airflow entering second cavity 16 via second cavity inlet 162. At least a portion of the volatized second aerosol-forming substrate flows from the second cavity 106 into first porous heating element 122 via porous second surface 174 as indicated by the diagonal arrows 178. The portion of volatized second aerosol-forming substrate flowing into first airflow channel 110 and the airflow entering first airflow channel 110 via first airflow inlet 164 mix in first airflow channel 110. Such mixture flows into chamber 152 via open and 130 of first airflow channel 110. At least a portion of the volatized second aerosol-forming substrate flows into chamber 152 of mouthpiece 112 via open and 132 of second cavity 106. The different airflows entering chamber 152 mix in chamber 152. The airflows entering chamber 152 may cool in chamber 152, such that an aerosol is formed. The aerosol is inhaled through aerosol outlet 152.

FIG. 9 shows a cylindrical porous heating element 122. Heating element 122 is produced using sintering. During sintering, spherical particles or granules are fused together by the application of high temperature and pressure to produce a continuous porous structure.

FIG. 10 shows two different planar porous heating elements 122. Heating elements 122 may be produced using sintering of particles or granules. On the left-hand side is a top view 180 of each of the two heating elements 122. In the central position, a corresponding side view 182 of the heating elements 122 as shown. A corresponding three-dimensional view 184 of the heating elements 122 is shown on the right-hand side.

The heating element 122 at the top is a uniform heating element 122. The heating element is planar. The heating element has a rectangular cross-section.

The heating element 122 is made from fused particles or granules of a single type. The particles or granules each have substantially the same size. The particles or granules each have substantially the same shape. The particles or granules are each made of the same material. The heating element 122 has a substantially uniform porosity. The electromagnetic response to an alternating magnetic field across the heating element 122 is substantially uniform.

The heating element 122 may have a first surface 186 and a second surface 188. The heating profile of heating element 122 may be substantially uniform across first surface 186 of heating element 122. The heating profile of heating element 122 may be substantially uniform across second surface 188 of heating element 122. The heating profile of the first surface 186 and may be the same as the heating profile of the second surface 188.

When arranged in first airflow channel 110 of device 102, the uniform heating element 122 may be used to uniformly heat an aerosol-forming substrate inserted into one or both of first cavity 106 and second cavity 108. By providing power only to the first induction coil, only the first surface may be heated. By providing power only to the second induction coil, only the second surface may be heated. By providing power to both, first induction coil and the second induction coil, first surface 186 and the second surface 188 may be heated. The uniform heating element may be used with uniform aerosol-forming substrates.

The heating element at the bottom comprises a first portion 190 and a second portion 192. First portion 190 abuts second portion 192. Second portion 192 is arranged proximal to first portion 190, or vice versa. First portion 190 is made of fused particles or granules of a first type. Second portion 192 is made of fused particles or granules of a second type. The first type of particles or granules may be different to the second type of particles or granules. The first portion may have a different porosity to the second portion. First portion 190 may have a different electromagnetic response to an alternating magnetic field than second portion 192. First portion 190 may have a different temperature profile than second portion 192.

The material of the first type of particles or granules and the material of the second type of particles or granules may be different. By providing a first type of particles or granules made from a different material than the second type of particles or granules, the electromagnetic response to an alternating magnetic field of the first portion 190 and the second portion 192 may be different.

The size of the first type of particles or granules and the size of the second type of particles may be different. By providing a first type of particles or granules having a different size than the second type of particles or granules, the porosity of the first section 190 and the second section 192 may be different.

The two-portion heating element comprises an overall first surface 186 and an overall second surface 188. When the two-portioned heating element is arranged in the first airflow channel 110, first overall surface 186 abuts first cavity 106 and second overall surface abuts 188 second cavity 108. First overall surface 186 may heat first aerosol-generating article 116 inserted into first cavity 106. Second overall surface 188 may heat second aerosol-generating article 118 inserted into second cavity 108.

The two-portioned heating element 122 may be used to heat non-uniform aerosol-generating articles 116 and 118 or non-uniform aerosol forming substrates

First overall surface 190 may comprise a first surface 194 of first portion 190 and a first surface 196 of second portion 192. The heating profile of first surface 194 of first portion 190 may be different to the heating profile of first surface 196 of second portion 192. First surface 194 of first portion 190 may heat a first portion of first aerosol-generating article 116 inserted into first cavity 106. First surface 196 of second portion 192 may heat a second portion of first aerosol-generating article 116 inserted into first cavity 106.

Second overall surface 192 may comprise a second surface 198 of first portion 190 and a second surface 200 of second portion 192. The heating profile of second surface 198 of first portion 190 may be different to the heating profile of second surface 200 of second portion 192. Second surface 198 of first portion 190 may heat a first portion of second aerosol-generating article 118 inserted into second cavity 108. Second surface 200 of second portion 192 may heat a second portion of second aerosol-generating article 118 inserted into second cavity 108.

The porosity of first portion 190 may be adapted to characteristics of the first portion of one or both of first aerosol-generating article 116 and second aerosol-generating article 118. The porosity of second portion 192 may be adapted to characteristics of the second portion of one or both of first aerosol-generating article 116 and second aerosol-generating article 118. The heating profile of first portion 190 may be adapted to characteristics of the first portion of one or both of aerosol-generating article 116 and second aerosol-generating article 118. The heating profile of second portion 192 may be adapted to characteristics of the second portion of one or both of aerosol-generating article 116 and second aerosol-generating article 118.

Concerning measurement indicated by the letters of FIG. 10, L may be of between 10 millimeters and 30 millimeters, preferably of between 15 millimeters and 20 millimeters, LA may be of between 5 millimeters and 20 millimeters, preferably of between 5 millimeters and 15 millimeters, LB may be of between 5 millimeters and 20 millimeters, preferably of between 5 millimeters and 15 millimeters, W may be of between 7 millimeters and 17 millimeters, preferably of between 10 millimeters and 15 millimeters, and T may be of between 1.5 millimeters and 5 millimeters, preferably of between 2 millimeters and 4 millimeters.

FIG. 11 shows a planar porous heating element. FIG. 11 shows a top view 180 of heating element 122, a bottom view 202 of heating element 122, a side view 182 of heating element 122 and three-dimensional view 184 of heating element 122. The heating element of FIG. 11 comprises first portion 190 and second portion 192. Heating element 122 may be made by sintering.

First portion 190 is arranged parallel to second portion 192. First portion 190 and second portion 192 form a stack. First portion 190 is made of fused particles or granules of a first type. Second portion 192 is made of fused particles or granules of second type. The first type of particles or granules may be different to the second type of particles or granules. First portion 190 may have a different porosity to second portion 192. First portion 190 may have a different electromagnetic response to an alternating magnetic field than second portion 192. First portion 190 may have a different temperature profile than second portion 192.

The material of the first type of particles or granules and the material of the second type of particles or granules may be different. By providing a first type of particles or granules made from a different material than the second type of particles or granules, the electromagnetic response to an alternating magnetic field of first portion 190 and second portion 192 may be different.

The size of the first type of particles or granules and the size of the second type of particles may be different. By providing a first type of particles or granules having a different size than the second type of particles or granules, the porosity of first section 190 and second section 192 may be different.

The two-portioned heating element 122 of FIG. 11 comprises a porous first surface 204 and a porous second surface 206. First surface 204 is a radial surface of first portion 190. First surface 204 forms the bottom surface of the stack shown in FIG. 11. Second surface 206 is a radial surface of second portion 192. Second portion 206 forms the top surface of the stack shown in FIG. 11. When heating element 122 of FIG. 11 is arranged in the first airflow channel 110, first surface 204 abuts first cavity 106 and second surface 206 abuts second cavity 108. First surface 204 may heat first aerosol-generating article 116 inserted into first cavity 106. Second surface 204 may heat second aerosol-generating article 118 inserted into second cavity 108.

Heating element 122 of FIG. 11 may be used to provide different heating profiles to different aerosol-generating articles or aerosol-forming substrates.

First surface 204 may be heated by first induction coil 120. Second surface 206 may be heated by second induction coil 126. The heating profile delivered by first surface 204 may be different than the heating profile delivered by second surface 206. The porosity of first portion 190 and first surface 204 may be different to the porosity of second portion 192 and second surface 206. The porosity of first portion 190 and first surface 204 may be adapted to characteristics of one or both of the first aerosol-forming substrate and first article 116. The porosity of second portion 192 and second surface 206 may be adapted to characteristics of one or both of the second aerosol-forming substrate and second article 118. The heating profile of first surface 204 may be adapted to characteristics of one or both of the first aerosol-forming substrate and article 116. The heating profile of the second surface 206 may be adapted to characteristics of one or both of the second aerosol-forming substrate and second article 118.

The measurements indicated with respect to FIG. 10 equally apply to the measurements of the heating element shown in FIG. 11. TA may be of between 0.35 millimeters and 2.5 millimeters, preferably of between 0.75 millimeters and 1.75 millimeters, and TB may be of between 0.35 millimeters and 2.5 millimeters, preferably of between 0.75

1.-15. (canceled)

16. An aerosol-generating device, comprising:
a first cavity configured to receive a first aerosol-forming substrate;
a second cavity configured to receive a second aerosol-forming substrate; and
a heating arrangement comprising a first porous heating element,
wherein the first porous heating element is arranged in a first airflow channel between the first cavity and the second cavity,
wherein the first porous heating element is further arranged abutting the first cavity and the second cavity, and
wherein the first porous heating element is fluidly connected with both of the first cavity and the second cavity.

17. The aerosol-generating device according to claim 16, wherein the first porous heating element is planar.

18. The aerosol-generating device according to claim 16, wherein the first porous heating element comprises a first portion and a second portion.

19. The aerosol-generating device according to claim 18,
wherein the first portion of the first porous heating element comprises a first porosity, and
wherein the second portion of the first porous heating element comprises a second porosity.

20. The aerosol-generating device according to claim 18, wherein the first portion of the first porous heating element is made from a first material and the second portion of the first porous heating element is made from a second material.

21. The aerosol-generating device according to claim 18, wherein the first portion of the first porous heating element is arranged abutting the second portion of the first porous heating element.

22. The aerosol-generating device according to claim 18, wherein the second portion of the first porous heating element is arranged proximal to the first portion of the first porous heating element.

23. The aerosol-generating device according to claim 22, wherein the first portion of the first porous heating element and the second portion of the first porous heating element are arranged abutting the first cavity and the second cavity.

24. The aerosol-generating device according to claim 18, wherein the first portion of the first porous heating element and the second portion of the first porous heating element are arranged parallel to each other.

25. The aerosol-generating device according to claim 24,
wherein the first portion of the first porous heating element is arranged abutting the first cavity, and
wherein the second portion of the first porous heating element is arranged abutting the second cavity.

26. The aerosol-generating device according to claim 16, wherein the first porous heating element comprises a first surface configured abutting the first cavity and a second surface configured abutting the second cavity.

27. The aerosol-generating device according to claim 26, wherein the first surface and the second surface are configured to be smooth.

28. The aerosol-generating device according to claim 16,
further comprising an aerosol outlet,
wherein the first porous heating element is configured to fluidly connect one or both of the first cavity and the second cavity with the aerosol outlet.

29. The aerosol-generating device according to claim 16,
wherein the heating arrangement further comprises a first planar induction coil,
wherein the first planar induction coil is configured abutting the first cavity,
wherein the heating arrangement comprises a second planar induction coil, and
wherein the second planar induction coil is configured abutting the second cavity.

30. An aerosol-generating system comprising the aerosol-generating device according to claim 16 and a first aerosol-forming substrate.

31. The aerosol-generating system according to claim 30, wherein the first aerosol-forming substrate is a first planar aerosol-forming substrate.

32. The aerosol-generating system according to claim 30, further comprising a second aerosol-forming substrate.

33. The aerosol-generating system according to claim 31, wherein the second aerosol-forming substrate is a second planar aerosol-forming substrate.
